(19) United States
(12) Patent Application Publication
(10) Pub. No.: US 2008/0212932 A1
(43) Pub. Date: Sep. 4, 2008

(54) SYSTEM FOR MANAGING VIDEO BASED ON TOPIC AND METHOD USING THE SAME AND METHOD FOR SEARCHING VIDEO BASED ON TOPIC

(75) Inventors: Yong Lee, Yongin-si (KR); Doo Sun Hwang, Seoul (KR); Ji Yeun Kim, Seoul (KR); Jeong Mi Cho, Suwon-si (KR); Sang Kyun Kim, Yongin-si (KR); Yong Ju Jung, Daejeon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/769,355

(22) Filed: Jun. 27, 2007

(30) Foreign Application Priority Data
Jul. 19, 2006 (KR) 10-2006-0067219

(51) Int. Cl. H04N 5/91

(52) U.S. Cl. 386/46; 386/E05.003

(57) ABSTRACT

A video management method and system based on a topic, and a video search method based on a topic. The video management system includes: a video topic management unit extracting a topic from information associated with a video, storing the extracted topic, and monitoring the video associated with the stored topic; a video storage management unit storing the video and information associated with the video, and managing a storage space based on the topic which is stored in the video topic management unit; and a topic video management unit generating a topic video of the monitored video when the video associated with the stored topic is monitored, and providing a search function and a navigation function of the video which is stored in the video storage management unit.

### CROSS-REFERENCE TO RELATED APPLICATION

This application claims the benefit of Korean Patent Application No. 10-2006-0067219, filed on Jul. 19, 2006, in the Korean Intellectual Property Office, the disclosure of which is incorporated herein by reference.

### BACKGROUND OF THE INVENTION

1. Field of the Invention

The present invention relates to a method and system for managing a video, and a method of performing a search on a video, and more particularly, to a method and system for managing a video based on a topic, and a method of performing a search on a video based on a topic, which can effectively store and manage the video based on the topic.

2. Description of Related Art

Due to an increase in broadcast channels and distribution of mass storage, users may view a broadcast program without restriction to a broadcast time, while recording broadcast programs which are broadcasted via a plurality of broadcast channels. However, a user usually does not have enough time to view every program. Also, the user is required to spend a great amount of time and perform many manipulations only for quickly looking over the recorded broadcast programs.

Also, in the case of a recording device, a storage where every space is stored is analogous to a limited size queue. Thus, an earliest recorded storage space must be deleted from the fully filled storage to record additional video.

Specifically, in the case of the recording device with the storage of the limited space, the additional video may be stored only after deleting an earliest recorded content. As an example, as shown in FIG. 1, when the recording device is filled after having video stored in a remaining space \textcircled{1} of the storage, and in this status, an additional video is recorded, an earliest content, which is recorded in a next space of the space \textcircled{1}, must be deleted to record the additional video. Namely, the recording device operates as a circular queue to perform recording. Also, it is possible to simultaneously perform deleting the earliest recorded content from the storage and storing the additional video.

Also, as shown in FIG. 1, in the case of a broadcast, a rebroadcast, or news with identical topics is frequently broadcasted, and stored in the storage. Accordingly, a storage efficiency of the storage is deteriorated.

Accordingly, a method and system for managing a video based on a topic, and a method of performing a search on a video based on a topic, which can effectively store and manage the video based on the topic is required.

### BRIEF SUMMARY

An aspect of the present invention provides a video management method and system, and a video search method based on a topic, which can effectively manage a storage space of a video based on a topic of the video.

Also, it is an aspect of the present invention to summarize a content of a video, which is stored in a video storage space, based on a topic, and to provide the summarized content.

Also, it is another aspect of the present invention to provide a search function of and a navigation function of a video, which is stored in a video storage space, based on a topic.

Also, it is still another aspect of the present invention to store a video about a user preference topic in a video storage space.

Also, it is yet another aspect of the present invention to provide a user with search convenience by providing a topic video when the user performs a search on a video. Here, the topic video stores a corresponding relation among a topic keyword, and a representative frame of a video associated with a topic, and a video associated with the topic.

Also, it is further aspect of the present invention to increase a system processing speed and enable a quick search and navigation of a video by providing a search function and a navigation function using a topic video.

According to an aspect of the present invention, there is provided a video management system including: a video topic management unit extracting a topic from information associated with a video, storing the extracted topic, and monitoring the video associated with the stored topic; a video storage management unit storing the video and information associated with the video, and managing a storage space based on the topic which is stored in the video topic management unit; and a topic video management unit generating a topic video of the monitored video when the video associated with the stored topic is monitored, and providing a search function and a navigation function of the video which is stored in the video storage management unit.

Also, the video storage management unit may include: a video receiver receiving the video and information associated with the video; a video storage unit storing the received video and information associated with the video; and a video storage space management unit managing the storage space, based on the stored topic.

Also, the video storage unit may include: a video database storing the video; a caption database storing a caption which is included in information associated with the video; and an Electronic Program Guide (EPG) database storing an EPS which is included in information associated with the video.

Also, the video storage space management unit may manage the storage space based on any one of the stored topic, the video which is stored in the storage space, and a storage time of information associated with the video, when the storage space is insufficient.

According to another aspect of the present invention, there is provided a method of managing a video storage space, the method including: extracting a topic from information associated with a video; storing the extracted topic; and managing the video storage space, based on the stored topic.

According to still another aspect of the present invention, there is provided a method of performing a search on a video, the method including: extracting a topic from information associated with the video, and storing the extracted topic; and displaying information associated with the stored topic; and performing a search on the video, which is stored in a storage space, by performing a search on information associated with the displayed information.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a diagram illustrating an example of a recording process of a recording device according to a conventional art;

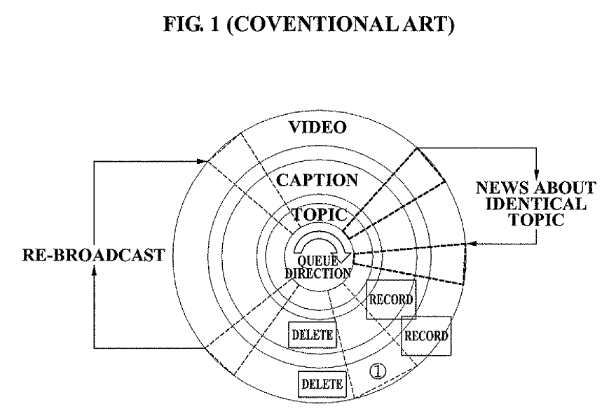

FIG. 2 is a block diagram illustrating a configuration of a video management system based on a topic according to an exemplary embodiment of the present invention;

FIG. 3 is a diagram illustrating an example of a process of extracting a topic according to an exemplary embodiment of the present invention;

FIG. 4 is a diagram illustrating an example of a recording process of a recording device according to an exemplary embodiment of the present invention;

FIG. 5 is a diagram illustrating an example of a topic navigation function according to an exemplary embodiment of the present invention;

FIG. 6 is a diagram illustrating an example of a screen of performing a search on and navigating a topic according to an exemplary embodiment of the present invention;

FIG. 7 is a flowchart illustrating a method of managing a video storage space based on a topic according to an exemplary embodiment of the present invention;

FIG. 8 is a flowchart illustrating a method of performing a search on a video based on a topic according to an exemplary embodiment of the present invention; and

FIG. 9 is a flowchart illustrating a method of performing operation S830 of FIG. 8.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

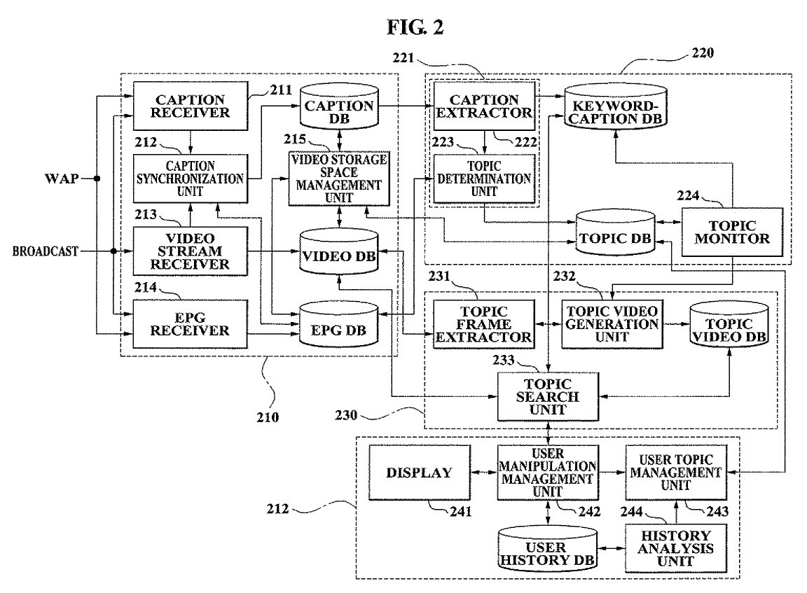

FIG. 2 is a block diagram illustrating a configuration of a video management system based on a topic according to an exemplary embodiment of the present invention.

Referring to FIG. 2, the video management system includes a video storage management unit 210, a video topic management unit 220, a topic video management unit 230, and a user preference topic management unit 240.

The video storage management unit 210 includes a caption receiver 211, a caption synchronization unit 212, a video stream receiver 213, an Electronic Program Guide (EPG) receiver 214, a video storage space management unit 215, a caption database, a video database, and an EPG database. Specifically, the video storage management unit 210 includes a video receiver, a video storage unit, and the video storage space management unit 215. Here, the video receiver includes the caption receiver 211, the caption synchronization unit 212, the video stream receiver 213, and the EPG receiver 214. Also, the video storage unit includes the caption database, the video database, and the EPG database.

The caption receiver 211 receives a caption from web or a broadcast.

The video stream receiver 213 receives a video stream from the broadcast, and stores the received video stream in the video database. In this case, the video stream consists of an image and a speech.

The BPG receiver 214 receives an EPG from the web or the broadcast, and stores the received EPG in the EPG database.

The caption synchronization unit 212 synchronizes a signal which is received from the caption receiver 211, a signal which is received from the video stream receiver 213, and a signal which is received from the EPG receiver 214. Also, the caption synchronization unit 212 stores a caption, which is received in the caption receiver 211, in the caption database.

The video storage space management unit 215 may manage the caption database, the video database, and the EPG database, based on a topic which is stored in the video topic management unit 220.

When a storage space of the caption database, the video database, and the EPG database is insufficient, the video storage space management unit 215 may manage the storage space based on any one of the stored topic, the video, which is stored in the storage space, and a storage time of information associated with the video. In this case, the video storage space management unit 215 may manage the storage space based on the storage time of the caption and the EPG.

Also, when the storage space of the caption database, the video database, and the EPG database is insufficient, the video storage space management unit 215 may delete a duplicate content of an identical topic from the storage space of the caption database, the video database, and the EPG database.

Also, the video storage space management unit 215 may manage the caption database, the video database, and the EPG database according to a predetermined importance of the topic which is stored in the video topic management unit 220. Here, the importance of the topic may be determined based on a frequency of a keyword which is extracted from the caption.

The video topic management unit 220 includes a topic extractor 221, a topic monitor 224, a keyword-caption database, and a topic database. The topic extractor 221 includes a caption extractor 222 and a topic determination unit 223.

The caption extractor 222 generates a corresponding relation between the keyword and the caption by linguistically analyzing the caption, and stores corresponding relation information in the keyword-subtitle database.

The topic determination unit 223 selects an important topic based on EPG information and the keyword which is analyzed in the caption extractor 222, and stores the selected topic in the topic database. Specifically, the topic extractor 221 extracts a keyword from caption information, and extracts a topic based on the extracted keyword and EPG information. Here, the topic database may store a user preference topic which is outputted from the user preference topic management unit 240.

The topic monitor 224 monitors whether a video associated with the topic, which is stored in the topic database, is generated from the keyword-caption database, and outputs a predetermined signal to the topic video management unit 230. Here, the signal is associated with whether the video associated with the stored topic is inputted.

In this case, the topic monitor 224 may monitor the keyword-caption database in real time or at a predetermined time interval.

The topic video management unit 230 includes a topic frame extractor 231, a topic video generation unit 232, a topic search unit 233, and a topic video database.

The topic frame extractor 231 extracts a representative frame of the video, which is associated with the monitored topic in the topic monitor 224, from the video database.

When the topic monitor 224 monitors the video of the stored topic in the topic database, the topic video generation unit 232 generates the topic video, based on a corresponding relation among a topic keyword of the monitored video, the representative frame of the topic, which is extracted in the topic frame extractor 231, and a section where the topic occurred. Also, the topic video generation unit 232 stores the generated topic video in the topic video database.

The topic search unit 233 provides a user with a function so that the user can perform a search on and navigate a topic. Specifically, the video storage management unit 210 provides a search function and a navigation function of the video, which is stored in the video storage management unit 210, by using the topic.

In this case, the topic search unit 233 may perform a search on the topic by using the topic video which is stored in the topic video database. Also, the topic search unit 233 may perform a search on the topic by using data, which is stored in the keyword-caption database.

When performing a search on a topic, the topic is inputted via a user manipulation management unit 242, and a desired topic may be designated via a keyboard, a voice interface capable of changing a voice into a text, and a recommendation. Also, the search may be performed with additional conditions, such as, a broadcast time, a broadcasting company, a genre, and the like.

When a user preference topic management unit 240 includes a display 241, the user manipulation management unit 242, a user topic management unit 243, a history analysis unit 244, and a user history database.

The display 241 corresponds to a user interface, and displays information about a search and navigation of the topic.

The user manipulation management unit 242 manages the user's manipulation, and displays a corresponding result on the display 241.

The user history database stores a history about the user's manipulation.

The history analysis unit 244 analyzes a major pattern based on the history about the user's manipulation. Specifically, the history analysis unit 244 performs an analysis process to extract a user preference topic. In this case, the user preference topic may be analyzed based on a topic which a user has recently performed a search on, a topic which is discussed in a broadcast program that the user frequently views, and the like. Also, when a plurality of users exists, such as with a television, the history analysis unit 244 may manage a history for each user. Also, the history analysis unit 244 may classify and analyze the user preference topic for each user.

The user topic management unit 243 stores the extracted topic based on the analysis of the history analysis unit 244, and a topic which is directly inputted by the user, i.e. the user preference topic, in the topic database.

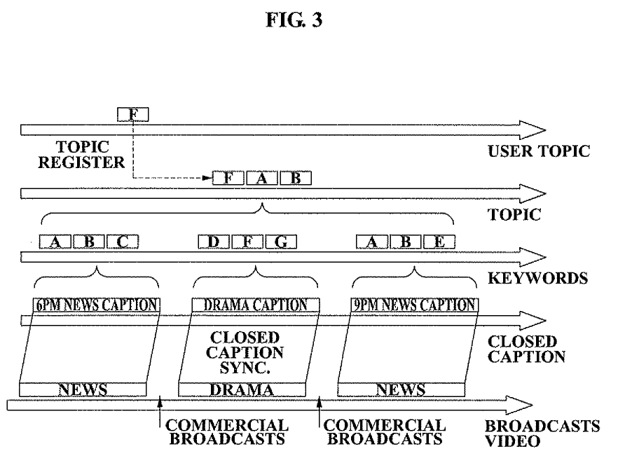

FIG. 3 is a diagram illustrating an example of a process of extracting a topic in a video management system according to an exemplary embodiment of the present invention.

Referring to FIG. 3, when the video storage management unit 210 receives a video and caption information, the caption extractor 222 of the video topic management unit 220 extracts a keyword from the caption, and stores information about the extracted keyword in the keyword-caption database. As an example, the caption extractor 222 extracts keywords A, B, and C, from a 6 pm news caption, extracts keywords D, F, and G from a drama caption, and extracts keywords A, B, and E, from a 9 pm news caption.

The topic determination unit 223 analyzes the extracted keywords A through F, and determines a key keyword as a topic. Also, the topic determination unit 223 stores the determined topic in the topic database. As an example of a method of determining a topic in the topic determination unit 223, the topic determination unit 223 may statistically process occurrences of the extracted keywords, and determine the topic. Also, as an example, the more frequently occurred keywords A and B are determined as the topic. In this case, the topic, which is stored in the topic database, includes the topic which is determined in the topic determination unit 223, and the user preference topic which is outputted in the user preference topic management unit 240. Here, the importance of the topic, which is stored in the topic database, may be determined in an order of a greatest number of occurrences. A comparatively higher order may be given to the user preference topic than to the topic which is determined in the topic determination unit 223. However, the importance of the topic is not limited thereto, and also may be variable depending upon circumstances.

When the topic is stored in the topic database via the above-described process, the topic monitor 224 monitors whether an inputted video is associated with the stored topic in the topic database in real time or at a predetermined time interval by using video caption information which is stored in the keyword-caption database.

As a result of the monitor of the topic monitor 224, when the inputted video is associated with the stored topic in the topic database, for example, the user preference topic F, data associated with the topic F is outputted to the topic video management unit 230.

The topic video management unit 230 generates a topic video about the monitored topic F, and stores the generated topic video in the topic video database. Specifically, the topic frame extractor 231 extracts a representative frame of the topic F from the video database. The topic video generation unit 232 generates the topic video based on a corresponding relation among the representative frame of the topic F a topic keyword F, and a section where the topic F occurred, and stores the generated topic video in the topic video database. In this instance, it is possible to select an initial or a latest video file about the topic F, and the representative frame of the topic F, and store the selected video file and the representative frame in the video database.

In this case, the generated topic video may be utilized when the user executes a search function or a navigation function of the video.

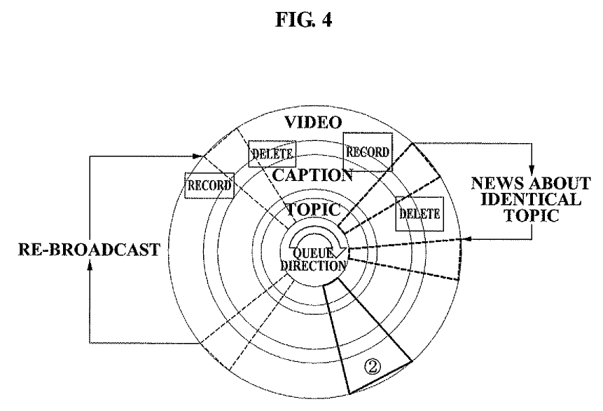

FIG. 4 is a diagram illustrating an example of a process of managing a storage space when a video about a duplicate topic is stored in the storage space of a video management system according to an exemplary embodiment of the present invention.

Referring to FIG. 4, when the storage space is insufficient, a video storage space according to the present exemplary embodiment does not delete an earliest recorded video and information about the video. The video storage space deletes a video containing a duplicate topic and information about the video, and stores additional video.

As an example, as shown in FIG. 4, when an identical video is duplicated in the video storage space due to a re-broadcast or when news is about an identical topic, which is not completely the same but similar to some extents, is duplicated in the video storage space, a duplicate content is deleted, and additional video is stored in the freed storage space. Thus, the additional video may be stored without deleting the earliest recorded video.

Further describing the deleting of duplicate content with reference to FIG. 2, when the video storage space, i.e. the storage space of the caption database, the video database, and the EPG database is insufficient to store addition video, the video storage space management unit 215 determines whether a duplicate copy of video exists via the topic which is stored in the topic database. When a duplicate copy of video exists, the video storage space management unit 215 deletes the duplicate copy of the video, and frees the storage space. Also, when the duplicate copy of video does not exist, the video storage space management unit 215 frees the video storage space based on an importance of the topic which is stored in the topic database. As an example, when a video stored in a storage space \textcircled{2} is an earliest recorded video, but the video has a comparatively more important topic, the video is not deleted from the storage space \textcircled{2}. Specifically, an additional storage is secured by deleting a video which has a less important topic, thereby freeing the storage space. Also, when two videos have an identical topic importance in the topic database, i.e. when occurrence frequencies of two videos are identical to each other, a video is deleted from the two videos by using another condition, for example, a storage time, and the like.

As described above, when managing the video storage space using a topic, it is possible to prevent a user's desired topic from being deleted. Also, an additional video may be stored by deleting a duplicate content. Thus, a comparatively more important video may be stored in the storage space for a longer time. Also, since a recording time according to a limit of the storage space is managed by using a topic, it is possible to store a video of a meaningful and important topic in a major portion of the storage space.

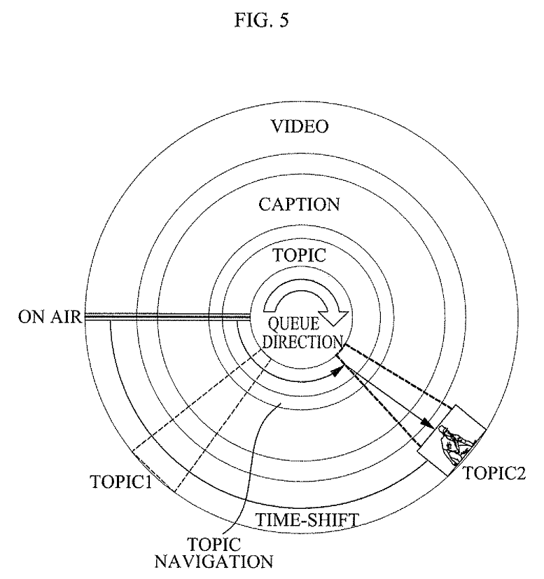

FIG. 5 is a diagram illustrating an example of a topic navigation function using the topic search unit 233 of FIG. 2.

Referring to FIG. 5, in the case of a conventional broadcast navigation based on a time-shift, the broadcast navigation goes back to a time axis to plays a video. However, a topic navigation according to the present exemplary embodiment performs a navigation function based on a topic. Thus, when selecting a topic, it is possible to go to a storage space of a video of the selected topic and play the video, not simply going backwards on a time axis. Specifically, a user is not required to view a video which is stored in the storage space to find a desired scene. The user may play a video of a desired topic by selecting the desired topic.

Referring again to FIG. 2, the user manipulation management unit 242 may perform the topic navigation function, based on a topic video which is stored in the topic video database, or information which is stored in the keyword-caption database by using the topic search unit 233.

As an example, in the conventional art, a user must check all the news to know what kinds of topics have been discussed in the news during a week. However, according to the present invention, an important topic is selected based on a caption of each news, and a content about the selected topic is provided to the user. Thus, the user may easily and quickly acquire desired information. Also, it is possible to classify and provide the selected topic for each kind. Also, since the topic video which is stored in the topic video database or the representative frame about the topic is provided together with the topic, the user may easily recognize and perform a search on the topic.

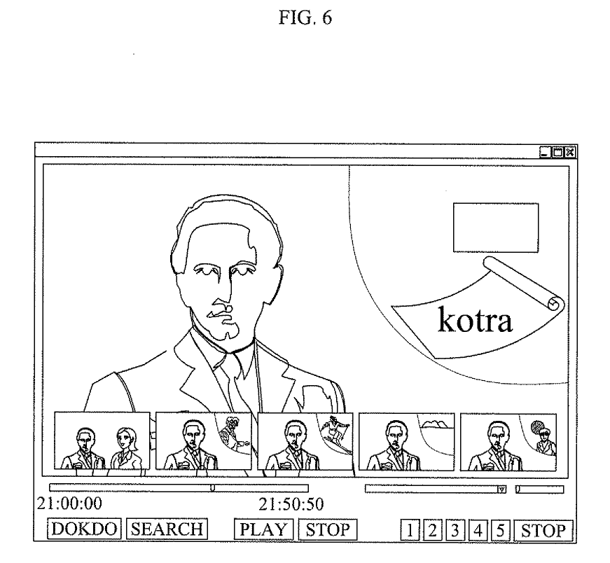

FIG. 6 is a diagram illustrating an example of a screen of performing a search on and navigation of a topic via a system according to an exemplary embodiment of the present invention.

As shown in FIG. 6, when a user inputs a topic “dokdo” and performs a search on the topic “dokdo”, a video or a representative frame associated with the topic “dokdo” is displayed. In this case, the user may display the video by selecting the video or the representative frame.

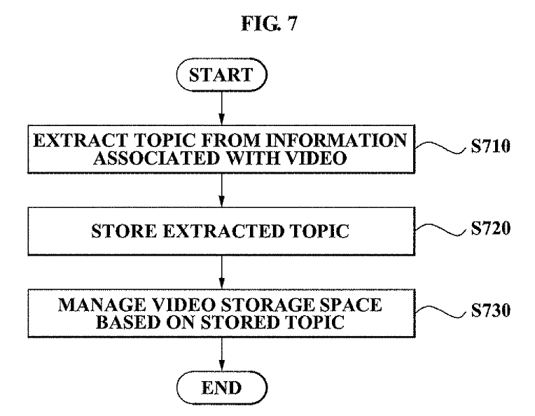

FIG. 7 is a flowchart illustrating a method of managing a video storage space based on a topic according to an exemplary embodiment of the present invention, the method including extracting a topic from information associated about a video (operation S710), storing the extracted topic (operation S720), and managing a video storage space based on the stored topic (operation S730).

In this instance, operation S730 may manage the video storage space based on the stored topic and a video storage time, when the storage space is insufficient.

Also, operation S730 may delete a duplicate copy of video of an identical topic when the video storage space is insufficient and contents of the identical topic duplicate copy of the video.

Also, operation S730 may manage the video storage space according to a predetermined importance of the stored topic when the video storage space is insufficient.

In this instance, information associated with the video includes a video caption and an EPG.

Also, operation S710 may extract a keyword from the video caption, and extract the topic based on the extracted keyword and the EPG.

Also, operation S720 may store the extracted topic and a user preference topic which is directly inputted by a user or extracted based on the user's manipulation history.

Referring to FIG. 7, in the method of managing a video storage space according to the present exemplary embodiment, in operation S710, a topic is extracted by using EPG information and video caption information which is inputted via a web or a broadcast. Specifically, a keyword is extracted from a caption and whether the extracted keyword is the topic is determined. Depending upon the determination, the topic may be extracted. Also, the determination may be made by statistically processing an occurrence frequency of the extracted keyword. In operation S720, the extracted topic is stored in a topic database. The topic database may include the topic which is extracted from the caption. Also, the topic database may include a topic which is extracted by analyzing a user history or a topic which is directly inputted by a user.

Specifically, the video storage space according to the present exemplary embodiment may be managed based on topics which are stored in the topic database. Thus, it is possible to store a video content about a user preference topic for a long period of time. Also, it is possible to prevent a waste of the storage space which may occur due to duplicate contents. Thus, the video storage space may be effectively utilized.

As an example, when a user desires to store only the user's desired topic in the video storage space, the user may directly input a user preference topic into the topic database. In this case, even when the storage space is insufficient due to a video which is stored in the video storage space, a video about the user preference topic may be not deleted. A video about another topic may be deleted. Thus, an additional video may be stored. When repeating the above-described process, only videos about user preference topics may remain in the video storage space. A function of managing a storage space using a topic, as described above, may be applicable to all fields which intends to store only information about a desired topic.

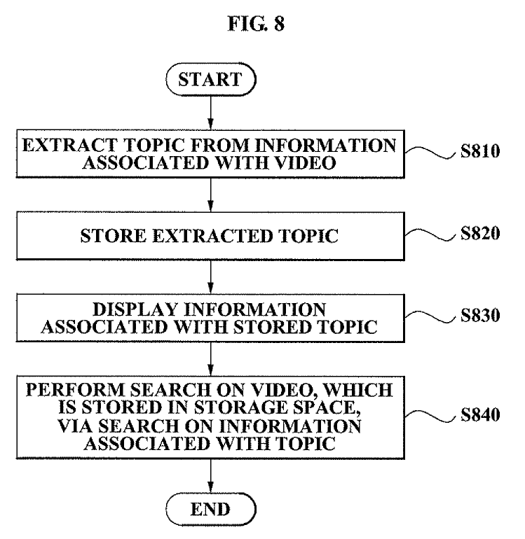

FIG. 8 is a flowchart illustrating a method of performing a search on a video based on a topic according to an exemplary embodiment of the present invention, the method including extracting a topic from information associated with the video, and storing the extracted topic (operations S810 and S820), displaying information associated with the stored topic (operation S830), and performing a search on the video, which is stored in a storage space, by performing a search on information associated with the displayed information (operation S840).

In this instance, information associated with the video may include a video caption and an EPG.

Also, operation S810 may extract a keyword from the video caption, and extract the topic based on the extracted keyword and the EPG.

Also, operation S830 may display a topic video, which is generated based on a corresponding relation between the topic and a section where the topic occurred.

Referring to FIG. 8, in the method of managing a video storage space according to the present exemplary embodiment, in operation S810, a topic is extracted by using EPG information and video caption information which is inputted via a web or a broadcast. Specifically, a keyword is extracted from a caption and whether the extracted keyword is the topic is determined. Depending upon the determination, the topic may be extracted. Also, the determination may be made by statistically processing an occurrence frequency of the extracted keyword. In operation S820, the extracted topic is stored in a topic database. The topic database may include the topic which is extracted from the caption. Also, the topic database may include a topic which is extracted by analyzing a user history or a topic which is directly inputted by a user.

In operation S830, information associated with the stored topic is displayed to perform a search on the video. Also in operation S830, a topic video which is generated based on a corresponding relation between the topic and a section where the topic occurred, may be displayed.

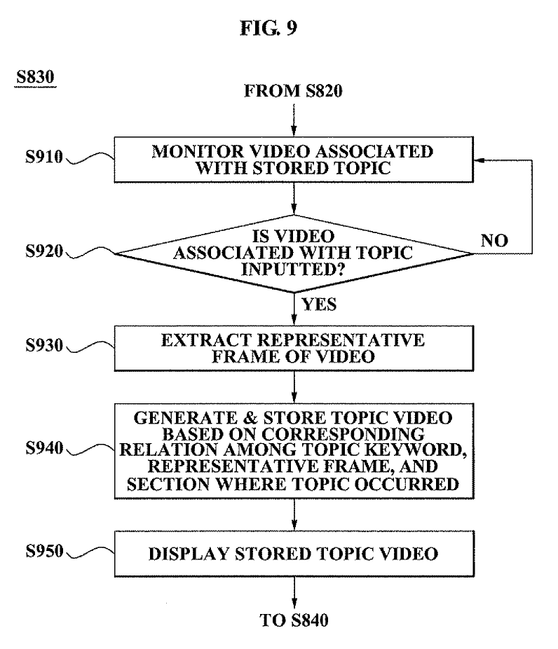

FIG. 9 is a flowchart illustrating a method of performing operation S830 of FIG. 8, the method including monitoring the video associated with the stored topic (operation S910), extracting a representative frame of the monitored video when the video associated with the stored topic is inputted (operations S920 and S930), generating and storing the topic video based on a corresponding relation among a topic keyword of the monitored video, the representative frame, and the section where the topic occurred (operation S940), and displaying the stored video topic (operation S950).

Referring to FIG. 9, in operation S910, whether the video associated with the stored topic is inputted is monitored.

When the video associated with the stored is inputted as a result of the monitoring in operation S920, a representative frame of the monitored video is extracted from the video database in operation S930. In operation S940, the topic video is generated based on a corresponding relation among a topic keyword of the monitored video, the extracted representative frame, and a section where the topic occurred. Here, the section is monitored to perform a search function and a navigation function. The generated topic video is stored in a predetermined storage area, for example, a memory.

In operation S950, the stored topic video is displayed. A video search process is performed by operations described above.

Also, although the present invention describes that a video search function and a video navigation function are performed using a topic, the present invention is not limited thereto. As an example, a user may check a topic of a video which is stored in a video storage space via a user interface. Also, the user may check only a desired topic via a topic search.

Also, according to the present invention, it is possible to provide a screen for a topic keyword and a representative frame via a topic video. Thus, a content about a video, which is stored in a video storage space, may be checked even quicker and thus, a desired video may be found even quicker.

The topic search function and the topic navigation function as described above may provide a user convenience. As an example, a user may check a topic on a screen in real time. Also, the user may check a topic which is being discussed in each broadcasting company at a glance. Also, the user may perform a search on another broadcast which is stored in a storage space, and play the found broadcast. Specifically, since the user may quickly perform a search on the user's desired broadcast and play the found broadcast, it is possible to increase the user's satisfaction and improve the user convenience.

Also, the topic navigation function may be provided for each genre, such as, a drama, news, sports, and the like.

The video storage space management method and the video search method according to the above-described exemplary embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the above-described exemplary embodiments of the present invention, there is provided a video management method and system, and a video search method based on a topic, which can effectively manage a video storage space and prevent an unnecessary use of storage space since the storage space of the video is managed based on a topic of the video.

Also, according to the above-described exemplary embodiments of the present invention, it is possible to summarize a content of a video, which is stored in a video storage space, based on a topic and to provide the summarized content.

Also, according to the above-described exemplary embodiments of the present invention, since a search function and navigation function of a video which is stored in a video storage space is provided based on a topic, it is possible to provide a user with user convenience to enable the user to quickly search a desired video.

Also, according to the above-described exemplary embodiments of the present invention, it is possible to store only a video about a user preference topic in a video storage space by enabling a user to set the user preference topic.

Also, according to the above-described exemplary embodiments of the present invention, it is possible to provide a search function and a navigation function using a representative frame of a topic by providing a topic video when the user performs a search on a video. Here, the topic video stores a corresponding relation among a topic keyword, and a representative frame of a video associated with a topic, and a video associated with the topic.

Also, according to the above-described exemplary embodiments of the present invention, it is possible to increase a system processing speed and enable a quick search and navigation of a video by providing a search function and a navigation function using a topic video.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A video management system comprising:
a video topic management unit extracting a topic from information associated with a video, storing the extracted topic, and monitoring the video associated with the stored topic;
a video storage management unit storing the video and information associated with the video, and managing a storage space based on the topic which is stored in the video topic management unit; and
a topic video management unit generating a topic video of the monitored video when the video associated with the stored topic is monitored, and providing a search function and a navigation function of the video which is stored in the video storage management unit.

2. The video management system of claim 1, wherein the video storage management unit comprises:
a video receiver receiving the video and information associated with the video;
a video storage unit storing the received video and information associated with the video; and
a video storage space management unit managing the storage space, based on the stored topic.

3. The video management system of claim 2, wherein the video storage unit comprises:
a video database storing the video;
a caption database storing a caption which is included in information associated with the video; and
an Electronic Program Guide (EPG) database storing an EPG which is included in information associated with the video.

4. The video management system of claim 2, wherein the video storage space management unit manages the storage space based on any one of the stored topic, the video which is stored in the storage space, and a storage time of information associated with the video, when the storage space is insufficient.

5. The video management system of claim 1, wherein the video topic management unit comprises:
a topic extractor extracting the topic based on information associated with the video;
a topic storage unit storing the extracted topic; and
a topic monitor monitoring the video associated with the topic, which is stored in the topic storage unit, from information associated with the video.

6. The video management system of claim 5, wherein the topic extractor extracts a keyword from caption information, which is included in information associated with the video, and extracts the topic, based on the extracted keyword and EPG information which is included in information associated with the video.

7. The video management system of claim 1, wherein the topic video management unit generates the topic video based on a corresponding relation between the topic of the monitored video and a section where the topic occurred, when the video associated with the stored topic is monitored.

8. The video management system of claim 1, wherein the topic video management unit comprises:
a topic frame extractor extracting a representative frame of the video, which is associated with the monitored topic, from video data which is stored in the storage space;
a topic video generation unit generating the topic video, based on a corresponding relation among a topic keyword of the monitored video, the representative frame, and a section where the topic occurred;
a topic video storage unit storing the generated topic video; and
a topic search unit providing the search function and the navigation function of the video, which is stored in the video storage management unit.

9. The video management system of claim 8, wherein the topic search unit provides the search function and the navigation function of the video, which is stored in the video storage management unit, using the stored topic video.

10. The video management system of claim 1, wherein the video topic management unit stores a user preference topic, and monitors a video associated with the user preference topic.

11. The video management system of claim 10, further comprising:
a user preference topic management unit managing the user preference topic, and outputting the user preference topic to the video topic management unit.

12. A method of managing a video storage space, the method comprising:
extracting a topic from information associated with a video;
storing the extracted topic; and
managing the video storage space, based on the stored topic.

13. The method of claim 12, wherein the managing manages the video storage space based on the stored topic and a video storage time, when the storage space is insufficient.

14. The method of claim 12, wherein the managing deletes a duplicate copy of video of an identical topic when the video storage space is insufficient and contents of the identical topic duplicate copy of the video.

15. The method of claim 12, wherein the managing manages the video storage space according to a predetermined importance of the stored topic when the video storage space is insufficient.

16. The method of claim 12, wherein information associated with the video comprises a video caption and an EP.

17. The method of claim 16, wherein the extracting extracts a keyword from the video caption, and extracts the topic based on the extracted keyword and the EPG.

18. The method of claim 12, wherein the storing stores the extracted topic and a user preference topic which is directly inputted by a user or extracted based on the user's manipulation history.

19. A method of performing a search on a video, the method comprising:
extracting a topic from information associated with the video, and storing the extracted topic; and
displaying information associated with the stored topic; and
performing a search on the video, which is stored in a storage space, by performing a search on information associated with the displayed information.

20. The method of claim 19, wherein information associated with the video comprises a video caption and an EPG.

21. The method of claim 20, wherein the extracting extracts a keyword from the video caption, and extracts the topic based on the extracted keyword and the EPG.

22. The method of claim 19, wherein the displaying displays a topic video, which is generated based on a corresponding relation between the topic and a section where the topic occurred.

23. The method of claim 22, wherein the displaying comprises:
monitoring the video associated with the stored topic;
extracting a representative frame of the monitored video when the video associated with the stored topic is monitored;
generating and storing the topic video based on a corresponding relation among a topic keyword of the monitored video, the representative frame, and the section where the topic occurred; and
displaying the stored topic video.

24. A computer-readable recording medium storing a program for implementing a method of managing a video storage space, the method comprising:
extracting a topic from information associated with a video;
storing the extracted topic; and
managing the video storage space, based on the stored topic.
